(19) United States
(12) Patent Application Publication
(10) Pub. No.: US 2019/0359091 A1
(43) Pub. Date: Nov. 28, 2019

(54) VEHICLE SEAT DEVICE

(71) Applicant: TOYOTA BOSHOKU KABUSHIKI KAISHA, Aichi-ken (JP)

(72) Inventors: Katsuhito YAMAUCHI, Aichi-ken (JP); Nobuki HAYASHI, Aichi-ken (JP); Tokuyuki NISHIKAWA, Aichi-ken (JP); Takeshi YAMADA, Aichi-ken (JP)

(73) Assignee: TOYOTA BOSHOKU KABUSHIKI KAISHA, Aichi-ken (JP)

(21) Appl. No.: 16/416,807

(22) Filed: May 20, 2019

(30) Foreign Application Priority Data
May 23, 2018 (JP) 2018-098611

(51) Int. Cl. B60N 2/24; B60N 2/02

(52) U.S. Cl. CPC B60N 2/24; B60N 2002/247; B60N 2002/0268; B60N 2/0244

(57) ABSTRACT

A vehicle seat device including: a seat main body; and a movable body, wherein a seat surface portion of the seat main body is configured to be switched between: a first posture in which the seat surface portion is brought down to a front side such that a first support surface is in a low position where the seated person can sit thereon by lowering a hip; and a second posture in which the seat surface portion is brought up to a rear side from the first posture such that a second support surface is in a high position where the seated person in a standing posture can sit thereon, and wherein the movable body includes a placement portion configured to swing with respect to the floor in a state where both soles of the seated person are placed when the seat surface portion is in the second posture.

### CROSS-REFERENCE TO RELATED APPLICATIONS

This application claims priority from Japanese Patent Application No. 2018-098611 filed on May 23, 2018, the entire contents of which are incorporated herein by reference.

### TECHNICAL FIELD

The present disclosure relates to a vehicle seat device.

### BACKGROUND ART

In the related art, as a seat provided for a vehicle such as an industrial vehicle, there is known a standing type seat in which a seated person can be seated in a standing posture (JP-A-2012-116218). The seat has a configuration in which a seat surface portion for supporting buttocks of the seated person is inclined downward to a front side. With the above configuration, the seated person can be seated on the seat surface portion in a state in which an angle of the pelvis is close to an angle in the standing posture, so that a raised sitting posture in which fatigue feeling is less can be obtained.

In the related art described above, the seat surface portion cannot be switched to enable the seated person to lower the hip to sit, and can be used only in the raised sitting posture. Further, there is a problem that a natural exercise load cannot be given to the body of the seated person to realize health promotion when being used in the raised sitting posture.

### SUMMARY

The present disclosure provides a vehicle seat device in which a seat surface portion is appropriately switched between a state corresponding to a raised sitting posture and a state corresponding to a sitting posture, and a natural exercise load can be given to a body of a seated person to realize health promotion when being used in the raised sitting posture.

According to an aspect of the disclosure, there is provided a vehicle seat device including: a seat main body attached to a floor and including: a seat surface portion to be seated by a seated person and having a first support surface and a second support surface; and a switching mechanism by which the seat surface portion is configured to be brought down to a front side or brought up to a rear side by rotation with respect to the floor; and a movable body on which feet of the seated person of the seat main body is to be placed so as to be supported relative to the floor, wherein the seat surface portion is configured to be switched by the switching mechanism between: a first posture in which the seat surface portion is brought down to the front side such that the first support surface facing an upper side is in a low position where the seated person is capable of sitting thereon by lowering a hip and the second support surface facing the front side forms a lead-in surface which is led downward to the rear side; and a second posture in which the seat surface portion is brought up to the rear side from the first posture such that the second support surface is pulled up to a position higher than a position of the first support surface in the first posture, an upper surface of the second support surface is inclined downward to the front side due to the lead-in surface, and the second support surface is in a high position where the seated person in a standing posture is capable of sitting thereon, and wherein the movable body includes a foot placement portion having a flat surface shape, the foot placement portion being configured to swing back and forth, right and left in all directions with respect to the floor in a state where both soles of the seated person are placed on the foot placement portion when the seat surface portion is in the second posture.

Accordingly, in the seat main body, by the switching of the posture of the seat surface portion by the switching mechanism, the seat surface portion can be appropriately switched between a state corresponding to a raised sitting posture and a state corresponding to a sitting posture. Specifically, by the second support surface which is a front surface inclined downward to the rear side when the seat surface portion is in the first posture, a space that allows a lower leg portion of the seated person to be led to the rear side can be formed when the seat surface portion is used in the first posture, and a seat surface inclined downward to the front side and suitable for supporting the buttocks of the seated person in the raised sitting posture can be rationally formed when the seat surface portion is used in the second posture. Further, when the seat surface portion is in the state corresponding to the raised sitting posture, since both feet of the seated person are supported in a state where the soles are placed on the foot placement portion of the movable body, the feet are unstable and need to be balanced. Accordingly, a natural exercise load can be given to the body of the seated person to realize health promotion.

According to another aspect of the disclosure, there is provided the movable body that realizes the vehicle seat device according to the above-described aspect.

According to another aspect of the disclosure, there is provided the seat main body that realizes the vehicle seat device according to the above-described aspect.

### BRIEF DESCRIPTION OF DRAWINGS

FIG. 1 is a perspective view showing a schematic configuration of an automobile seat device according to an embodiment of the present disclosure, where a seat surface portion of a seat main body is shown in a forward turned down posture,

FIG. 2 is a perspective view showing a state in which the seat surface portion of the seat main body of the embodiment is switched to a flip-up posture,

FIG. 3 is a side view showing a state in which the seat surface portion of the seat main body of the embodiment is in the forward turned-down posture,

FIG. 4 is a side view showing a state in which the seat surface portion of the seat main body is switched from the forward turned-down posture to the flip-up posture and a footrest body is in a locked state,

FIG. 5 is a side view showing a state in which the seat surface portion of the seat main body is switched from the forward turned-down posture to the flip-up posture and the footrest body is in a unlocked state,

FIG. 6 is a block diagram showing an operation of the embodiment, and

FIG. 7 is a flowchart showing the operation of the embodiment.

### DETAILED DESCRIPTION

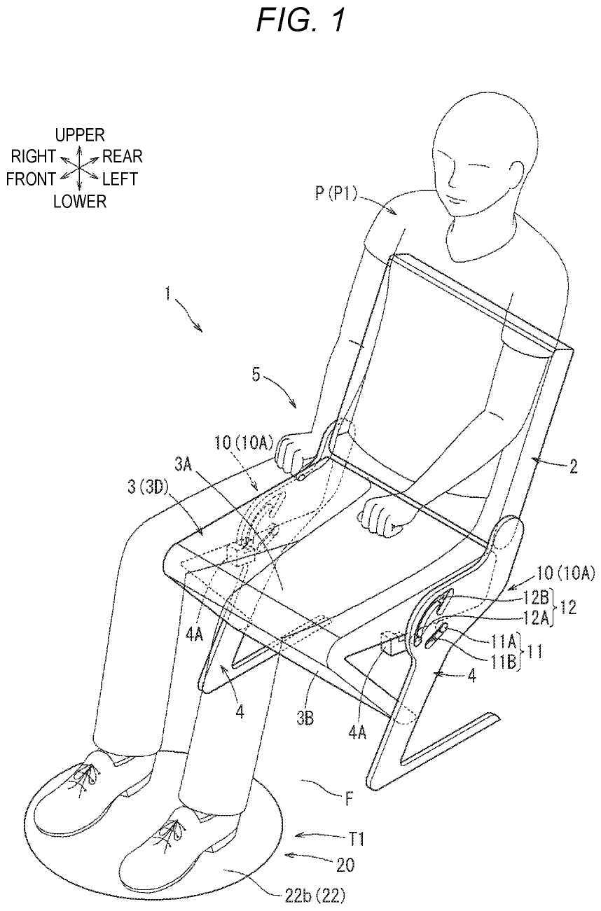

A configuration of an automobile seat device 1 according to an embodiment of the present disclosure will be described with reference to FIGS. 1 to 5. In the following description, each direction, such as front, rear, upper, lower, left, and right, indicates the respective directions shown in the drawings. As shown in FIG. 1, the automobile seat device 1 of the present disclosure includes a seat main body 5 and a footrest body 20. Here, the automobile seat device 1 corresponds to “vehicle seat device” in the claims.

As shown in FIGS. 1 to 5, the seat main body 5 is configured as an automobile seat, and includes a backrest surface portion 2 which is a backrest for a seated person P, and a seat surface portion 3 which is a seating surface.

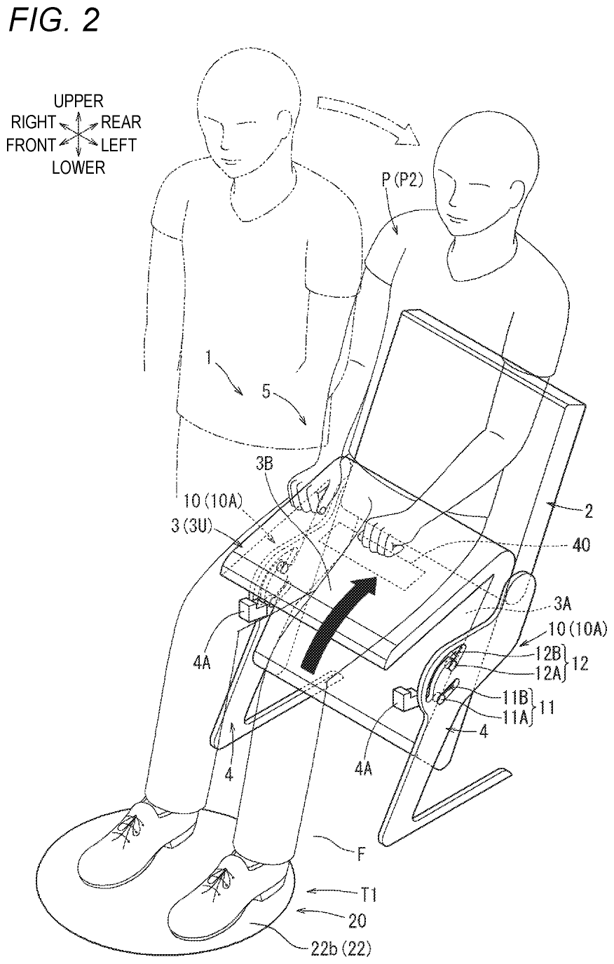

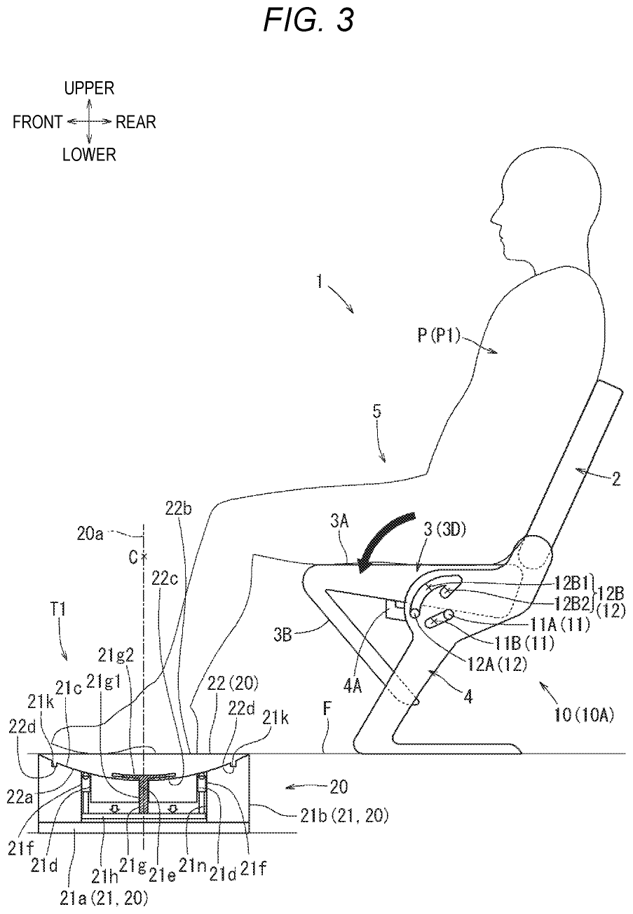

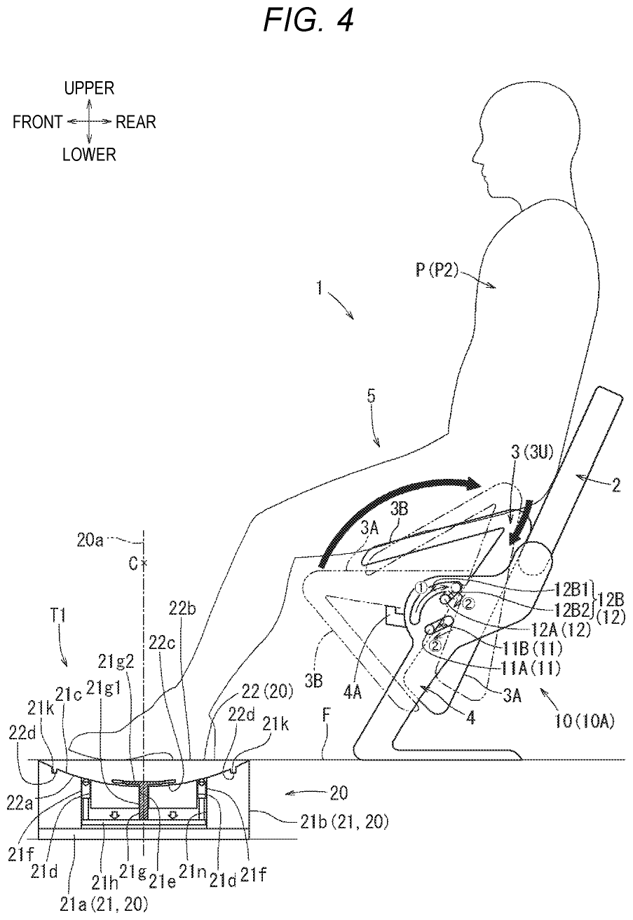

The backrest surface portion 2 is provided in a state in which lower end portions thereof on both left and right sides are respectively fixed in positions corresponding to a pair of left and right bases 4 provided on a floor F of the vehicle. The backrest surface portion 2 is provided in a state in which a front surface, which is a backrest surface, forms an inclined surface slightly inclined rearward than the vertical direction. Further, the seat surface portion 3 is connected in a state in which side surface portions thereof on both left and right sides can be rotated in a rising/falling manner in a front-rear direction with respect to the pair of left and right bases 4 respectively. Specifically, the seat surface portion 3 is configured such that a posture thereof is switched between a forward turned-down posture 3D as shown in FIG. 1 and FIG. 3, and a flip-up posture 3U as shown in FIG. 2 and FIG. 4 by a switching mechanism 10 having a pair of left and right configuration respectively provided between side surface portions and bases 4 on both left and right sides.

By being switched to the forward turned down posture 3D as shown in FIG. 1 and FIG. 3, the seat surface portion 3 is held at a low position where the seated person P can lower the hip to sit in a sitting posture P1. Further, by being switched to the flip-up posture 3U as shown in FIG. 2 and FIG. 4, the seat surface portion 3 is held at a high position where the seated person P can be seated in a standing posture (in a raised sitting posture P2). The raised sitting posture P2 enables the seated person P to take a posture with less fatigue feeling in which an angle of the pelvis is close to an angle in the standing posture.

Specifically, as shown in FIG. 1 and FIG. 3, the seat surface portion 3 is formed of a single plate member which is bent in a substantially V shape in a side view. The seat surface portion 3 is configured such that when being switched to the forward turned down posture 3D, a first support surface 3A thereof which faces an upper side forms a substantially horizontal seating surface at a low position where the seated person P can lower the hip to sit in. Further, a second support surface 3B of the seat surface portion 3 which faces a front side forms a lead-in surface which is led downward to a rear side. Due to the second support surface 3B forming the lead-in surface, a space that allows a lower leg portion of the seated person P to be led to the rear side when the sitting person P is seated on the seat surface portion 3 is formed.

The seat surface portion 3 is configured such that when being switched from the forward turned down posture 3D to the flip-up posture 3U as shown in FIG. 2 and FIG. 4, the first support surface 3A is brought up 90 degrees or more rearward from the position of the forward turned down posture 3D, and is brought close to a position facing the front surface of the backrest surface portion 2. Further, the seat surface portion 3 is configured such that the second support surface 3B forming the lead-in surface is pulled up to a position higher than the first support surface 3A in the forward turned down posture 3D, and is switched to a state in which the second support surface 3B forms an upper surface which is inclined downward to the front side. Due to this switching, a seating surface on which the seated person P can be seated in the raised sitting posture P2 is formed by the second support surface 3B brought up to a high position and inclined downward to the front side. A seating sensor 40 is disposed on an inner side of the second support surface 3B of the seat surface portion 3 to detect whether the sitting person P is seated on the second support surface 3B.

The second support surface 3B forming the seating surface in the raised sitting posture P2 forms a surface inclined downward to the front side, so that the second support surface 3B faces the buttocks of the seated person P in the raised sitting posture P2 with a wide surface, and thus an edge portion thereof on the front side is unlikely to form an overhanging shape that bites into the buttocks of the seated person P. Therefore, the seated person P seated on the seat surface portion 3 can take the raised sitting posture P2 with less fatigue feeling in which an angle of the pelvis is close to an angle in the standing posture with lower foreign matter feeling and good sitting comfort.

Specifically, the switching mechanism 10 is configured as follows so that the seat surface portion 3 is switched between the forward turned down posture 3D as shown in FIG. 1 and FIG. 3 and the flip-up posture 3U as shown in FIG. 2 and FIG. 4. That is, as shown in FIG. 1 and FIG. 3, the switching mechanism 10 is configured by pin connection portions 11 that rotatably pin-connect side surface portions on both left and right sides of the seat surface portion 3 to the bases 4 on each side, and slide connection portions 12 that connect the left and right side portions of the seat surface portion 3 with respect to the bases 4 on each side at positions spaced forward from the pin connection portions 11 in a state where the rotation around each pin connection portion 11 can be released by sliding. Further, the switching mechanism 10 includes a stopper 10A which can restrict the forward falling of the seat surface portion 3 when the seat surface portion 3 is switched to the flip-up posture 3U.

Each pin connection portion 11 includes a connecting pin 11A having a round bar shape and protruding outward in a seat width direction from both side surface portions of the seat surface portion 3, and a lead-in hole 11B formed through the base 4 on each side and extending obliquely forward and downward in a straight manner. Each connecting pin 11A is respectively inserted into the lead-in hole 11B from an inner side in the seat width direction, and is able to slide or pivot in the extending direction of the lead-in hole 11B only in each lead-in hole 11B.

Each slide connection portion 12 includes a slide pin 12A having a round bar shape and protruding outward in the seat width direction from both side surface portions of the seat surface portion 3, and a long hole 12B formed through the base 4 on each side and extending in a substantially arc-like curved shape. Each slide pin 12A is respectively inserted into the long hole 12B from the inner side in the seat width direction, and is able to slide or pivot in the extending direction only in each long hole 12B. As shown in FIG. 3, each long hole 12B is formed in a shape which includes a guide hole 12B1 curved in an arc shape drawn around the connecting pin 11A when the connecting pin 11A is located at an end portion on a rear upper side in the lead-in hole 11B, and a lead-in hole 12B2 extending in a form of being drawn straight forward and downward from an end portion on a rear upper side of the guide hole 12B1.

The switching mechanism 10 is configured such that when the seat surface portion 3 is in the forward turned down posture 3D, the connecting pin 11A of each pin connection portion 11 is positioned at the end portion on the rear upper side in the lead-in hole 11B, and the slide pin 12A of each slide connection portion 12 is positioned at the end portion on the front lower side of the guide hole 12B1 in each long hole 12B. With such a configuration, the switching mechanism 10 can hold the seat surface portion 3 in a constant position against its gravity action by means of a force with which the connecting pin 11A of each pin connection portion 11 hits the end portion on the rear upper side in the lead-in hole 11B, and a force with which the slide pin 12A of each slide connection portion 12 hits the end portion on the front lower side of the guide hole 12B1 in each long hole 12B. Further, in the forward turned down posture 3D, the seat surface portion 3 is also supported by a lower support portion 4A, which extends in an arm shape from the respective bases 4 to the front side, from the lower side in a region in front of the slide pins 12A.

When the seat surface portion 3 is lifted up to the rear side by a user from the state in which the seat surface portion 3 is in the forward turned down posture 3D, the switching mechanism 10 operates such that the slide pin 12A of the each slide connection portion 12 moves to the rear upper side along the hole shape of each guide hole 12B1 centering on each connecting pin 11A located at the end portion on the rear upper side in the lead-in hole 11B of each pin connection portion 11. At this time, each connecting pin 11A as the rotation center of each pin connection portion 11 is held in the constant position pressed against the end portion on the upper rear side in each lead-in hole 11B by the action of the force operated to lift up the seat surface portion 3 to the rear side.

As shown by an imaginary line in FIG. 4, when the seat surface portion 3 is lifted up to the rear side, the slide pin 12A of each slide connection portion 12 reaches the end portion on the rear upper side in each guide hole 12B1 and is locked. At this state, the seat surface portion 3 is operated to return to the original forward turned down direction, so that the seat surface portion 3 is returned in the forward turned down direction again centering on the connecting pin 11A of each pin connection portion 11. However, since the seat surface portion 3 is operated to drop in the direction of gravity from the state in which the seat surface portion 3 is lifted up to the rear side and locked, as shown by a solid line in FIG. 4, the connecting pin 11A of each pin connection portion 11 is led forward and downward along the hole shape of each lead-in hole 11B, and the slide pin 12A of each slide connection portion 12 is led forward and downward along the hole shape of each lead-in hole 12B2.

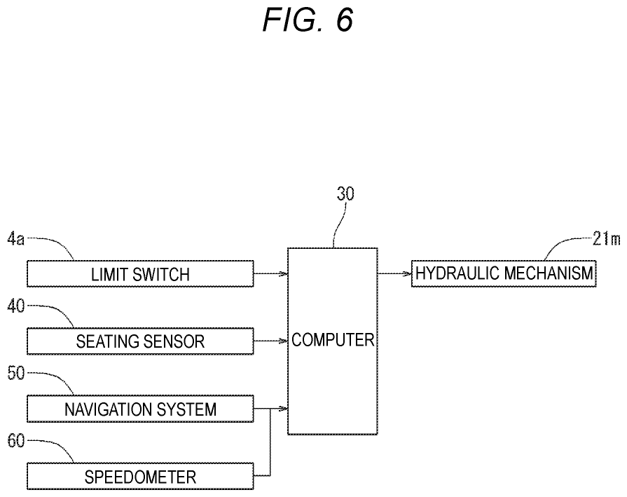

Due to the dropping, the connecting pin 11A of each pin connection portion 11 reaches the end portion on the front lower side of each lead-in hole 11B, and the slide pin 12A of each slide connection portion 12 reaches the end portion on the front lower side of each lead-in hole 12B2. Accordingly, the dropping of the seat surface portion 3 in the direction of gravity is locked. The dropping of the seat surface portion 3 in the direction of gravity can be locked either way since either of the connecting pin 11A and the slide pin 12A is locked when reaching the end portion of the lead-in hole 11B or the lead-in hole 12B2. Due to the dropping, the slide pin 12A of each slide connection portion 12 is restricted from moving forward in the direction of inclining around the connecting pin 11A of each pin connection portion 11, and the seat surface portion 3 is held in the flip-up posture position. A limit switch 4a (see FIG. 6) is disposed on the base 4 to detect that the slide pin 12A is positioned at the lower end portion of the lead-in hole 12B2.

Specifically, when the seat surface portion 3 is dropped in the direction of gravity from the position brought up to the rear side, since the shape of the lead-in hole 11B of each pin connection portion 11 is inclined at a front side with respect to the lead-in hole 12B2 of each slide connection portion 12, the first support surface 3A is sunk in a state of being substantially superimposed on the front surface of the backrest surface portion 2 while being slightly inclined rearward. According to the above configuration, when the seat surface portion 3 is lifted up to a position to be locked to the rear side, the seat surface portion 3 does not interfere with the backrest surface portion 2, and the operation of dropping the seat surface portion 3 in the direction of gravity from the position being locked to the rear side or the operation of pulling up from the dropped position can be smoothly performed without being disturbed by the interference with the backrest surface portion 2.

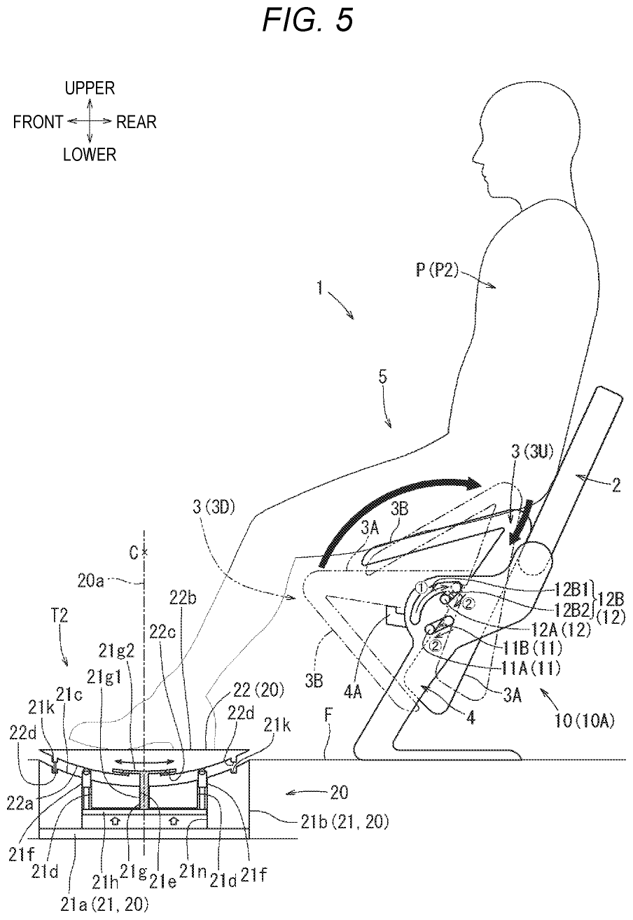

The operation for returning the seat surface portion 3 from the flip-up posture 3U being lifted up to the rear and dropped in the direction of gravity to the original forward turned down posture 3D as shown in FIG. 3 may be performed by operating the seat surface portion 3 in the reverse procedure to the above. According to such simple operation, the seat surface portion 3 can be switched between the forward turned down posture 3D at the low position where the seated person P can lower the hip to sit, and the flip-up posture 3U at the high position where the seated person P can be seated in the standing posture (see FIG. 5). Therefore, by appropriately switching and using the posture of the seat surface portion 3, it is possible to appropriately prevent the deterioration of the circulation of blood due to the seated person P continuing to sit in a constant posture. In addition, by being able to take the raised sitting posture P2 on the seating surface that is inclined downward to the front side, it is possible to favorably promote blood circulation in the calf in the comfortable raised sitting posture P2.

In summary, the automobile seat device 1 of present embodiment has the following configuration. That is, the automobile seat device 1 includes the seat surface portion 3 to be seated by the seated person P and having the first support surface 3A and the second supporting surface 3B, and the switching mechanism 10 by which the seat surface portion 3 is configured to be brought down to the front side or brought up to the rear side by rotation with respect to the floor F. The seat surface portion 3 is configured to be switched by the switching mechanism 10 between: the forward turned down posture 3D (first posture) in which the seat surface portion 3 is brought down to the front side such that first support surface 3A facing the upper side is in the low position where the seated person P is capable of sitting thereon by lowering the hip to sit (take the sitting posture P1) and the second support surface 3B facing the front side forms the lead-in surface which is led downward to the rear side; and the flip-up posture 3U (second posture) in which the seat surface portion 3 is brought up to the rear side from the forward turned down posture 3D such that the second support surface 3B is pulled up to a position higher than a position of the first support surface 3A in the forward turned down posture 3D, the upper surface of the second support surface 3B is inclined downward to the front side due to the lead-in surface, and the second support surface 3B is in the high position where the seated person P in the standing posture is capable of sitting thereon (take the raised sitting posture P2).

As described above, by the switching of the posture of the seat surface portion 3 by the switching mechanism 10, the seat surface portion 3 can be appropriately switched between a state corresponding to the raised sitting posture P2 (flip-up posture 3U) and a state corresponding to the sitting posture P1 (forward turned down posture 3D). Specifically, by the second support surface 3B formed as the front surface inclined downward to the rear side when the seat surface portion 3 is in the forward turned down posture 3D, the space that allows the lower leg portion of the seated person P to be led to the rear side can be formed when the seat surface portion 3 is used in the forward turned down posture 3D, and the seat surface inclined downward to the front side and suitable for supporting the buttocks of the seated person P in the raised sitting posture P2 can be rationally formed when the seat surface portion 3 is used in the flip-up posture 3U.

As shown in FIGS. 1 to 5, the footrest body 20 includes a fixed portion 21 which is disposed below the floor F, and a movable portion 22 which is placed on the fixed portion 21 and on which both soles of the seated person P are placed so as to support the soles. The footrest body 20 is formed in a cylindrical shape when the movable portion 22 is placed on the fixed portion 21 in a non-swingable state T1 described later. Here, the movable portion 22 corresponds to “movable body” in the claims.

The fixed portion 21 includes a disk-shaped base plate 21a and a main body portion 21b fixed on the base plate 21a. An upper surface portion 21c of the main body portion 21b is formed as a part of a spherical surface centered on a point C on a center axis 20a of the cylindrical shape. In the main body portion 21b, six cylindrical through holes 21d extending in an upper-lower direction are provided at a substantially center portion between the center axis 20a and an outer peripheral edge portion in top view. The six through holes 21d are disposed at equal intervals on the circumference with the same distance from the center axis 20a in top view. A cylindrical connecting hole 21n having a diameter that circumscribes the six through holes 21d is provided on the lower side of the six through holes 21d, and lower end portions of the six through holes 21d communicate with the connecting hole 21n. Further, a cylindrical central through hole 21e whose center axis is the center axis 20a is provided at the center of the main body portion 21b. A lower end portion of the central through hole 21e also communicates with the connecting hole 21n. The diameters of the through holes 21d and the central through holes 21e are substantially the same. In each of the through holes 21d, a ball roller 21f provided with a ball disposed on the upper side is disposed so as to be vertically movable. The ball roller 21f is a member rotatably supporting the ball in all directions on an upper portion of a cylindrical main body. Further, a swing control member 21g for controlling a swing range of the movable portion 22 is disposed in the central through hole 21e so as to be vertically movable. The swing control member 21g includes a cylindrical support rod portion 21g1 and a spherical shell 21g2 attached to an upper end portion of the support rod portion 21g1. The spherical shell 21g2 is formed so as to form a part of the spherical shell centered on the point C in the non-swingable state T1. A lower end portion of each ball roller 21f and a lower end portion of the support rod portion 21g1 are connected by a hydraulic mechanism 21m (see FIG. 6) to a movable disc 21h disposed so as to be vertically movable in the connecting hole 21n. Therefore, each ball roller 21f and the swing control member 21g are configured to be vertically movable at the same time by the up and down movement of the movable disc 21h. In the upper surface portion 21c of the main body portion 21b, engagement concave portions 21k to which engagement convex portions 22d of the movable portion 22 can engage are provided on a radially outer side of the through holes 21d. Here, the upper surface portion 21c corresponds to “concave surface portion” in the claims.

When in the non-swingable state T1 with respect to the fixed portion 21, the movable portion 22 is formed as a part of a sphere centered on the point C and including a lower surface portion 22a in close contact with the upper surface portion 21c of the main body portion 21b and a foot placement portion 22b flush with the floor F. A swing control hole 22c is provided on a lower surface portion 22a side of the movable portion 22. The swing control hole 22c is loosely fitted to the spherical shell 21g2 of the swing control member 21g of the fixed portion 21 so that the movable portion 22 can swing. The swing control hole 22c is formed as a part of the spherical shell centered on the point C when the movable portion 22 is in the non-swingable state T1 with respect to the fixed portion 21. In the lower surface portion 22a of the movable portion 22, engagement convex portions 22d which can be engaged corresponding to the engagement concave portions 21k of the fixed portion 21 are provided to protrude downward when the movable portion 22 is in the non-swingable state T1 with respect to the fixed portion 21. Here, the lower surface portion 22a corresponds to “convex surface portion” in the claims.

According to such a configuration, when the movable disc 21h of the fixed portion 21 is raised by the hydraulic mechanism 21m, the footrest body 20 is in a swingable state T2 in which the ball rollers 21f are raised and the balls support the movable portion 22 so as to be able to swing back and forth and right and left with respect to the fixed portion 21. At this time, since the spherical shell 21g2 of the swing control member 21g is loosely fitted in the swing control hole 22c of the movable portion 22, the swing is limited within a predetermined range. Further, when the movable disc 21h of the fixed portion 21 is lowered by the hydraulic mechanism 21m, the ball rollers 21f and the swing control member 21g are lowered, and the lower surface portion 22a of the movable portion 22 is in close contact with the upper surface portion 21c of the fixed portion 21. At this time, the engagement convex portions 22d of the movable portion 22 are engaged with the engagement concave portions 21k of the fixed portion 21 respectively, and the movable portion 22 is in the non-swingable state T1 in which the swing with respect to the fixed portion 21 is stopped.

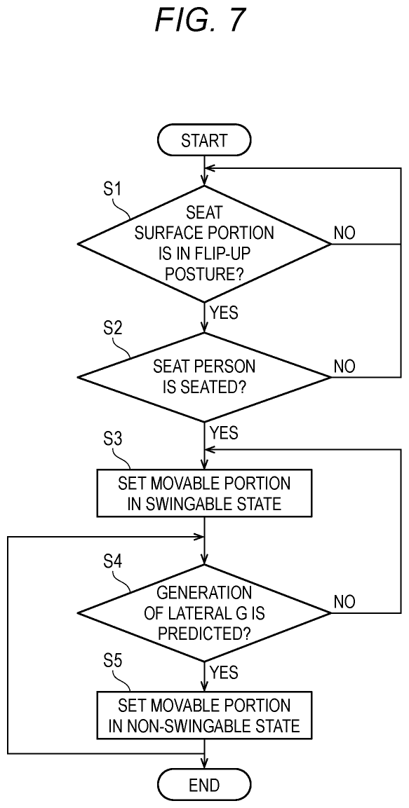

The operation of the footrest body 20 will be described with reference to FIGS. 6 and 7. FIG. 6 is a block diagram of a case where the operation of the footrest body 20 is implemented by the computer 30 of program control. The computer 30 is attached to the base 4, and detection signals from the limit switch 4a of the seat main body 5, the seating sensor 40, the navigation system 50 and the speedometer 60 are input. Further, the hydraulic mechanism 21m of the footrest body 20 is connected to the computer 30 so as to be operable.

FIG. 7 is a flow chart of operating the hydraulic mechanism 21m to set the movable portion 22 in the swingable state T2 or in the non-swingable state T1. In step S1, whether the seat surface portion 3 is in the flip-up posture 3U is determined based on a detection signal from the limit switch 4a. In a case where the seat surface portion 3 is in the flip-up posture 3U, the process proceeds to step S2, and in a case where the seat surface portion 3 is not in the flip-up posture 3U, step S1 is repeated.

In step S2, whether the seated person P is seated on the second support surface 3B of the seat surface portion 3 is determined based on a detection signal from the seating sensor 40. In a case where the seated person P is seated on the second support surface 3B, the process proceeds to step S3, and the hydraulic mechanism 21m is operated to set the movable portion 22 in the swingable state T2 in which the movable portion 22 is supported so as to be able to swing back and forth and right and left with respect to the fixed portion 21. In a case where the seated person P is not seated on the second support surface 3B, the process returns to step S1.

In step S4, whether generation of a lateral G equal to or larger than a predetermined value is predicted during the turning of the vehicle is determined based on detection signals from the navigation system 50 and the speedometer 60. In a case where the generation of the lateral G equal to or larger than the predetermined value is predicted, the process proceeds to step S5, and the hydraulic mechanism 21m is operated so as to set the movable portion 22 in the non-swingable stale T1 in which the movable portion 22 is supported so as to not be able to swing with respect to the fixed portion 21, and the process returns to step S4. In a case where the generation of the lateral G equal to or larger than the predetermined value is not predicted, the process returns to step S3.

The embodiment configured as described above has the following advantageous effects. As described above, in the seat main body 5, by the switching of the posture of the seat surface portion 3 by the switching mechanism 10, the seat surface portion 3 can be appropriately switched between a state corresponding to the raised sitting posture P2 and a state corresponding to the sitting posture P1. Specifically, by the second support surface 3B which is a front surface inclined downward to the rear side when the seat surface portion 3 is in the forward turned down posture 3D, the space that allows the lower leg portion of the seated person P to be led to the rear side can be formed when the seat surface portion 3 is used in the forward turned down posture 3D, and the seat surface inclined downward to the front side suitable for supporting the buttocks of the seated person P in the raised sitting posture P2 can be rationally formed when the seat surface portion 3 is used in the flip-up posture 3U. Further, when the seat surface portion is in the state corresponding to the raised sitting posture P2, since both feet of the seated person P are supported in a state where the soles are placed on the foot placement portion 22b of the movable portion 22, the feet are unstable and need to be balanced. Accordingly, a natural exercise load can be given to the body of the seated person P to realize health promotion.

Further, the movable portion 22 is configured to be in the non-swingable state T1 at the time of turning of the vehicle when generation of acceleration equal to or larger than a predetermined value by the turning is predicted based on detection signals from the navigation system 50 and the speedometer 60. Accordingly, the seated person P sitting in the raised sitting posture P2 at normal times needs to take balance in a state where the soles are placed on the foot placement portion 22b of the movable portion 22, so that the natural exercise load can be given to the body of the seated person P to realize health promotion for the seated person P. Meanwhile, the movable portion 22 is configured such that the foot placement portion 22b is in the non-swingable state T1 in the case where the generation of acceleration equal to or larger than the predetermined value by the turning of the vehicle is predicted, so that the seated person P can hold the feet for support such that the body does not fall down and is safe.

Further, the movable portion 22 is formed in a shape having the lower surface portion 22a at the lower side and the foot placement portion 22b at the upper side. At normal times, the ball portions of these six ball rollers 21f protrude from the upper surface portion 21c of the fixed portion 21 to swingably support the lower surface portion 22a. At the time of turning of the vehicle, the ball portions of these six ball rollers 21f withdraw from the upper surface portion 21c to bring the upper surface portion 21c and the lower surface 22a into contact with each other, and the engagement convex portion 22d is engaged with the engagement concave portion 21k to be in the non-swingable state T1. Therefore, a natural exercise load can be given to the body of the seated person P at normal times to realize health promotion for the seated person P, and the movable portion 22 can be in the non-swingable state T1 in the case where the generation of acceleration equal to or larger than the predetermined value by the turtling of the vehicle is predicted, so that the seated person P can hold the feet for support such that the body does not fall down and is safe.

Although a specific embodiment has been described above, the present disclosure is not limited to those configurations, and various modifications, additions and deletions are possible without changing the spirit of the present disclosure. For example, following matters are listed.

1. In the above embodiment, a case where the present disclosure is applied to the automobile seat device 1 is described, but the present disclosure is not limited thereto, and may be applied to a seat device mounted on a ship, a train, an airplane or the like other than an automobile.

2. In the above embodiment, vertical movement of the movable portion 22 is performed by the hydraulic mechanism 21m, but the present disclosure is not limited thereto, and a pneumatic mechanism or an electric mechanism may also be used.

The disclosure provides illustrative, non-limiting examples as follows:

According to a first aspect of the disclosure, there is provided a vehicle seat device including: a seat main body attached to a floor and including: a seat surface portion to be seated by a seated person and having a first support surface and a second support surface; and a switching mechanism by which the seat surface portion is configured to be brought down to a front side or brought up to a rear side by rotation with respect to the floor; and a movable body on which feet of the seated person of the seat main body is to be placed so as to be supported relative to the floor, wherein the seat surface portion is configured to be switched by the switching mechanism between: a first posture in which the seat surface portion is brought down to the front side such that the first support surface facing an upper side is in a low position where the seated person is capable of sitting thereon by lowering a hip and the second support surface facing the front side forms a lead-in surface which is led downward to the rear side; and a second posture in which the seat surface portion is brought up to the rear side from the first posture such that the second support surface is pulled up to a position higher than a position of the first support surface in the first posture, an upper surface of the second support surface is inclined downward to the front side due to the lead-in surface, and the second support surface is in a high position where the seated person in a standing posture is capable of sitting thereon, and wherein the movable body includes a foot placement portion having a flat surface shape, the foot placement portion being configured to swing back and forth, right and left in all directions with respect to the floor in a state where both soles of the seated person are placed on the foot placement portion when the seat surface portion is in the second posture.

According to the first aspect, in the seat main body, by the switching of the posture of the seat surface portion by the switching mechanism, the seat surface portion can be appropriately switched between a state corresponding to a raised sitting posture and a state corresponding to a sitting posture. Specifically, by the second support surface which is a front surface inclined downward to the rear side when the seat surface portion is in the first posture, a space that allows a lower leg portion of the seated person to be led to the rear side can be formed when the seat surface portion is used in the first posture, and a seat surface inclined downward to the front side and suitable for supporting the buttocks of the seated person in the raised sitting posture can be rationally formed when the seat surface portion is used in the second posture. Further, when the seat surface portion is in the state corresponding to the raised sitting posture, since both feet of the seated person are supported in a state where the soles are placed on the foot placement portion of the movable body, the feet are unstable and need to be balanced. Accordingly, a natural exercise load can be given to the body of the seated person to realize health promotion.

According to a second aspect of the disclosure, there is provided the vehicle seat device according to the first aspect, wherein the movable body is configured such that the foot placement portion is not able to swing at a time of turning of the vehicle when generation of acceleration equal to or larger than a predetermined value by the turning is predicted based on information from a navigation system or speedometer of the vehicle.

According to the second aspect, the seated person sitting in the standing posture at normal times needs to take balance in a state where the soles are placed on the foot placement portion of the movable body, so that the natural exercise load can be given to the body of the seated person to realize health promotion for the seated person. Meanwhile, the movable body is configured such that the foot placement portion is not able to swing in the case where the generation of acceleration equal to or larger than the predetermined value by the turning of the vehicle is predicted, so that the seated person can hold the feet for support such that the body does not fall down and is safe.

According to a third aspect of the disclosure, there is provided the vehicle seat device according to the first aspect, wherein the movable body is formed in a shape having a convex surface portion at a lower side and the foot placement portion at an upper side, the convex surface portion corresponding to a concave surface portion which is formed on the floor and forms a part of a spherical surface, and the foot placement portion being parallel to the floor, and wherein the movable body is supported by a plurality of ball rollers each including a ball portion, the ball portion protruding from the concave surface portion to swingably support the convex surface portion at normal times, and the ball portion withdrawing from the concave surface portion to bring the concave surface portion and the convex surface portion into contact with each other in a non-movable manner at a time of turning of the vehicle.

According to the third aspect, the operational effect of the second aspect of the disclosure can be exhibited with a simple structure.

According to a fourth aspect of the disclosure, there is provided the movable body that realizes the vehicle seat device according to any one of the first to third aspects.

According to a fifth aspect of the disclosure, there is provided the seat main body that realizes the vehicle seat device according to any one of the first to third aspects.

What is claimed is:

1. A vehicle seat device comprising:
a seat main body attached to a floor and including:
a seat surface portion to be seated by a seated person and having a first support surface and a second support surface; and
a switching mechanism by which the seat surface portion is configured to be brought down to a front side or brought up to a rear side by rotation with respect to the floor; and
a movable body on which feet of the seated person of the seat main body is to be placed so as to be supported relative to the floor,
wherein the seat surface portion is configured to be switched by the switching mechanism between:
a first posture in which the seat surface portion is brought down to the front side such that the first support surface facing an upper side is in a low position where the seated person is capable of sitting thereon by lowering a hip and the second support surface facing the front side forms a lead-in surface which is led downward to the rear side; and
a second posture in which the seat surface portion is brought up to the rear side from the first posture such that the second support surface is pulled up to a position higher than a position of the first support surface in the first posture, an upper surface of the second support surface is inclined downward to the front side due to the lead-in surface, and the second support surface is in a high position where the seated person in a standing posture is capable of sitting thereon, and
wherein the movable body includes a foot placement portion having a flat surface shape, the foot placement portion being configured to swing back and forth, right and left in all directions with respect to the floor in a state where both soles of the seated person are placed on the foot placement portion when the seat surface portion is in the second posture.

2. The vehicle seat device according to claim 1,
wherein the movable body is configured such that the foot placement portion is not able to swing at a time of turning of the vehicle when generation of acceleration equal to or larger than a predetermined value by the turning is predicted based on information from a navigation system or speedometer of the vehicle.

3. The vehicle seat device according to claim 1,
wherein the movable body is formed in a shape having a convex surface portion at a lower side and the foot placement portion at an upper side, the convex surface portion corresponding to a concave surface portion which is formed on the floor and forms a part of a spherical surface, and the foot placement portion being parallel to the floor, and
wherein the movable body is supported by a plurality of ball rollers each including a ball portion, the ball portion protruding from the concave surface portion to swingably support the convex surface portion at normal times, and the ball portion withdrawing from the concave surface portion to bring the concave surface portion and the convex surface portion into contact with each other in a non-movable manner at a time of turning of the vehicle.

4. The movable body that realizes the vehicle seat device according to claim 1.

5. The seat main body a realizes the vehicle seat device according to claim 1.
